(19) United States
(12) Patent Application Publication
(10) Pub. No.: US 2007/0154759 A1
(43) Pub. Date: Jul. 5, 2007

(54) Solid oxide fuel cell electric power generation apparatus

(75) Inventors: Michio Horiuchi, Nagano (JP); Yasue Tokutake, Nagano (JP); Shigeaki Suganuma, Nagano (JP); Jun Yoshiike, Nagano (JP); Fumimasa Katagiri, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/605,341

(22) Filed: Nov. 29, 2006

(30) Foreign Application Priority Data
Nov. 30, 2005 (JP) P. 2005-346299

(51) Int. Cl. H01M 8/04; H01M 8/12

(52) U.S. Cl. 429/26; 429/32

(57) ABSTRACT

The solid oxide fuel cell electric power generation apparatus comprises a fuel cell pair having solid oxide fuel cells C1 and C2 each comprising a flat solid electrolyte substrate 1 having a cathode electrode layer 2 and an anode electrode layer 3 formed thereon with a solid fuel F provided interposed between the anode electrode layer of the solid oxide fuel cell C1 and the anode electrode layer of the solid oxide fuel cell C2 and a heat supplying device for heating the fuel cell pair. When the fuel cell pair is heated, the solid fuel is directly put into gas phase as a fuel seed that is then supplied into the anode electrode layer to cause the solid oxide fuel cell to generate electricity.

### BACKGROUND OF THE INVENTION

1. Field of the Invention

The present invention relates to an electric power generation apparatus using a solid oxide fuel cell, and more particularly to a solid oxide fuel cell electric power generation apparatus which comprises a solid fuel provided between two sheets of solid oxide fuel cell each having a cathode electrode layer and an anode electrode layer formed thereon so that the fuel cell pair can be heated and thus is arranged so simply as to require no sealing, making it possible to directly put the solid fuel in gas phase that can be used as a fuel for the fuel cell to generate electricity.

2. Description of Related Art

In recent years, fuel cells of various types of electric power generation apparatus have been developed. Among these types of fuel cells, there is a solid oxide fuel cell of the type having a solid electrolyte. As an example of the fuel cell having the solid electrolyte, there is provided a one employing a sintered material made of stabilized zirconia to which an yttria (Y₂O₃) is added as an oxygen-ionically conductive solid electrolyte substrate. A cathode electrode layer is formed on one side of the solid electrolyte substrate while an anode electrode layer is formed on the other side of the solid electrolyte substrate. Oxygen or an oxygen-containing gas is supplied into the fuel cell on the cathode electrode layer side thereof while a fuel gas such as methane is supplied into the fuel cell on the anode electrode layer side thereof.

In this fuel cell, oxygen (O₂) which has been supplied into the cathode electrode layer is ionized to oxygen ion (O²⁻) at an interface between the cathode electrode layer and the solid electrolyte substrate. The oxygen ion is conducted through the solid electrolyte substrate to the anode electrode layer where it reacts with the supplied gas such as methane (CH₄) to produce water (H₂O), carbon dioxide (CO₂), hydrogen (H₂) and carbon monoxide (CO). In this reaction, oxygen ion releases electron to make some difference in potential between the cathode electrode layer and the anode electrode layer. Accordingly, when a lead wire is attached to the cathode electrode layer and the anode electrode layer so that electron in the anode electrode layer flows through the lead wire toward the cathode electrode layer, electric power is generated by a fuel cell. The driving temperature of the fuel cell is about 1,000° C.

However, this type of a fuel cell requires separate type chambers. That is, a chamber for an oxygen or oxygen-containing gas is required at the cathode electrode layer side and another chamber for a fuel gas is required at the anode electrode layer side thereof. Further, since this type of a fuel cell is exposed to an oxidizing atmosphere and a reducing atmosphere at high temperatures, it is difficult to enhance the durability of fuel cell unit.

On the other hand, a fuel cell has been developed which has a cathode electrode layer and an anode electrode layer provided on the opposing sides the solid electrolyte substrate, respectively, to form a fuel cell unit that is disposed in a fuel gas such as mixture of methane gas and oxygen gas to cause the generation of electromotive force between the cathode electrode layer and the anode electrode layer. The principle of this type of a fuel cell in the generation of electromotive force between the cathode electrode layer and the anode electrode layer is the same as that of the aforementioned separate chamber type fuel cell. However, since this structure has advantageous in that the solid oxide fuel cell can be entirely disposed in substantially the same atmosphere, it can be in the form of a single chamber to which a mixed fuel gas is supplied. Thus, it becomes possible to enhance the durability of the fuel cell.

However, the electric power generation apparatus of this single chamber type fuel cell, too, must be driven at a temperature as high as about 1,000° C. Thus, there is a risk of explosion of mixed fuel gas. When lowering the oxygen concentration the flammability limit to avoid this risk, the carbonation of the fuel such as methane proceeds, raising a problem of deterioration of cell performance. In order to solve this problem, a single chamber type fuel cell has been proposed which can employ a mixed fuel gas in an oxygen concentration allowing prevention of explosion of mixed fuel gas as well as prevention of progress of carbonation of fuel (see Japanese Patent Unexamined Publication JP-A-2003-92124)

The above proposed electric power generation apparatus of the fuel cell has a plurality of solid oxide fuel cells laminated in a chamber. On the other hand, as described in Japanese Patent Unexamined Publication JP-A-6-196176, a device has been proposed which generates electric power by disposing a cylindrical solid oxide fuel cell in or in the vicinity of flame so that the heat of flame causes the solid oxide fuel cell to be kept at its operating temperature.

The aforementioned single chamber type fuel cell electric power generation apparatus doesn't require that strictly separating the fuel and air from each other as in the related art solid oxide fuel cell electric power generation apparatus. However, instead, it requires a hermetically sealed structure. In the single chamber type fuel cell electric power generation apparatus, a plurality of sheet-like solid oxide fuel cells are laminated and connected to each other with an interconnect material having a high heat resistance and a high electrical conductivity to raise the electromotive force so that it can be driven at high temperatures. To this end, a single chamber type fuel cell electric power generation apparatus comprising a sheet-like solid oxide fuel cell requires a large-scaled structure that adds to cost to disadvantage. In operation, the operation of the single chamber type fuel cell electric power generation apparatus must be gradually heated to a high temperature to prevent the solid oxide fuel cell from being cracked. Thus, it is troublesome and takes much time to start electricity generation.

On the other hand, the solid oxide fuel cell in the aforementioned electric power generation apparatus is a type of direct utilization of flame. This type of a fuel cell is an open type which doesn't require that the fuel cell itself is accommodated in a hermetically sealed vessel. Therefore, this fuel cell can start electricity generation in a reduced period of time and has a single structure that reduces the size, weight and cost thereof to advantage. Further, since this fuel cell allows direct utilization of flame, it can be incorporated in ordinary combustion devices, incinerators, etc. and thus has been expected to be used as an electric power supply.

However, this type of a fuel cell electric power generation apparatus has an anode electrode layer formed on the outer surface of a cylindrical solid electrolyte layer. Therefore, radical components from the flame cannot be supplied into un upper half of the anode electrode layer, making it impossible to effectively utilize the entire surface of the anode electrode layer formed on the outer surface of the cylindrical solid electrolyte layer. Thus, this type of a fuel cell has a low electricity generation efficiency.

An electric power generation apparatus having a solid oxide fuel cell having an enhanced electricity generation efficiency has been proposed (see, e.g., Japanese Patent Unexamined Publication JP-A-2004-139936). The above proposed electric power generation apparatus is shown in FIG. 11. A specific configuration of the solid oxide fuel cell C utilized herein will be described hereinafter. The solid oxide fuel cell C has a cathode electrode layer 2 formed on one side of a solid electrolyte substrate 1 and an anode electrode layer 3 formed on the other side of the solid electrolyte substrate 1 and is generally in a flat sheet form.

As mentioned above, the cathode electrode layer 2 and the anode electrode layer 3 are formed on the flat sheet-like solid electrolyte substrate 1. In this arrangement, when the anode electrode layer 3 is disposed so as to be exposed to flame f generated by a gas burner 4, the anode electrode layer 3 side becomes fuel-rich. Then, the cathode electrode layer 2 necessarily faces the atmosphere and thus is oxygen-rich. The electric power thus outputted is then drawn out from the electric power generation apparatus through a lead wire L1 attached to the cathode electrode layer 2 and a lead wire L2 attached to the anode electrode layer 3.

As compared with the aforementioned cylindrical solid oxide fuel cell, the solid oxide fuel cell C is in a flat sheet form and thus can be uniformly exposed to flame. Further, the solid oxide fuel cell C is arranged such that the anode electrode layer 3 is disposed opposed to flame, making it easy to effectively use hydrocarbons, hydrogen, radicals (e.g., OH, CH, C₂, O₂H, CH₃), etc. present in flame generated by the combustion of gas as fuel seed.

In accordance with the electric power generation apparatus having a solid oxide fuel cell described above, flame f generated by the gas burner is applied directly to the anode electrode layer 3 to act as a heat source that maintains the operating temperature of the solid oxide fuel cell C as well as a source of fuel seed required for the generation of electricity by the solid oxide fuel cell. In the foregoing description, the flame f is generated by the combustion of gas. However, it has been also proposed that the solid oxide fuel cell be applied to electric power generation apparatus in such a manner that a solid fuel is combusted to generate flame f.

As the solid oxide fuel cell C used in the electric power generation apparatus of FIG. 12, there can be used one shown in FIG. 11. The solid oxide fuel cell C comprises a flat solid electrolyte substrate 1 and a cathode electrode layer (air electrode layer) 2 and an anode electrode layer (fuel electrode layer) 3 formed on the respective side of the flat solid. electrolyte substrate 1. The solid oxide fuel cell C is adapted to be placed on the top of a combustion device 5.

The combustion device 5 has a combustion chamber which accommodates a solid fuel F. In the combustion chamber, a retainer 6 such as grating is provided for supporting the solid fuel. In FIG. 12, a wood material is shown supplied as a solid fuel. The combustion device 5 has an opening for flame, which is provided at an upper part thereof for supporting the solid oxide fuel cell C and allowing the anode electrode 3 to face the combustion chamber so that it is exposed to flame. The combustion device 5 also has a solid fuel supply opening formed at the front face thereof for supplying the solid fuel F into the combustion chamber. The combustion device 5 further has an air intake opening formed at the front face thereof for supplying air into the lower part of the solid fuel retainer 6.

Besides the wood material, as the solid fuel there may be used an easily available material such as wood chip or pellet, paraffin, olefin and alcohol. The solid fuel F is supplied into the combustion chamber of the combustion device 5 and combusted to generate flame f. Flame f thus generated then tough the anode electrode layer 3 of the solid oxide fuel cell C disposed close to the open portion while external air is supplied into the cathode electrode layer 2. In this manner, radical components in flame f and oxygen in the air react with each other to generate an electromotive force between the lead wire L1 and the lead wire L2. Thus, the device acts as an electric power generation apparatus utilizing a solid oxide fuel cell.

In accordance with the aforementioned electric power generation apparatus utilizing a solid oxide fuel cell, a gas phase fuel is normally supplied into the fuel electrode. In the case of the solid oxide fuel cell accommodated in the single chamber type electric power generation apparatus, a mixed fuel gas is supplied into the fuel electrode. In a case where the solid oxide fuel cell electric power generation apparatus which uses directly the flame, the anode electrode layer is supplied with combusted gas or uncombusted gas contained in the flame generated by combustion of gas or solid fuel.

In order to produce a fuel gas contained in the mixed gas to be supplied into the device from the solid fuel as in the case of generation of electricity by the single chamber type electric power generation apparatus, however, it takes much time and energy that require a special producing device. When considering a point that utilizing the fuel combusted by the solid fuel, the solid oxide fuel cell electric power generation apparatus using flame directly is advantageous over the single chamber type electric power generation apparatus in that the solid fuel can be put into gas phase in the device more simply and easily. However, there leaves problem in the stabilization of flame generated by the combustion of a solid fuel and the efficiency of supply of fuel into the fuel electrode. Further, since the solid oxide fuel cell electric power generation apparatus using directly the flame must have a combustion device provided therein, it leaves problem in the reduction of size and thus cannot obtain an enhanced output of electric power.

### SUMMARY OF THE INVENTION

It is therefore an aim of the invention to provide a solid oxide fuel cell electric power generation apparatus which comprises a solid fuel provided interposed between two sheets of solid oxide fuel cell each having a cathode electrode layer and an anode electrode layer formed thereon so that the fuel cell pair can be heated and is arranged so simply as to require no sealing, making it possible to put the solid fuel in gas phase that can be used as a fuel for the fuel cell to generate electricity.

In order to solve the aforementioned problems, according to a first aspect of the invention, there is provided a solid oxide fuel cell electric power generation apparatus comprising:

first and second solid oxide fuel cells each comprising a flat solid electrolyte substrate having a cathode electrode layer and an anode electrode layer; and

a heat supplying device that heats the first and second solid oxide fuel cells,

wherein a solid fuel is provided between the anode electrode layer of the first solid oxide fuel cell and the anode electrode layer of the second solid oxide fuel cell.

According to a second aspect of the invention, as set forth in the first aspect of the invention, it is preferable that a metallic mesh is provided on the anode electrode layers.

According to a third aspect of the invention, as set forth in the first aspect of the invention, it is preferable that a heat insulating vessel surrounds at least a part of a side portion of a first fuel cell pair comprising the first solid oxide fuel cell, the second solid oxide fuel cell and the solid fuel provided therebetween and

the heat supplying device is disposed at a lower part of the heat insulating vessel and air is supplied into the heat insulating vessel from the lower part thereof.

According to a fourth aspect of the invention, as set forth in the third aspect of the invention, it is preferable that the first fuel cell pair is disposed vertically and

the heat supplying device is disposed under the first fuel cell pair.

According to a fifth aspect of the invention, as set forth in the fourth aspect of the invention, it is preferable that a plurality of the fuel cell pairs comprising the first solid oxide fuel cell, the second solid oxide fuel cell and the solid fuel provided therebetween, are accommodated in the heat insulating vessel so as to be apart from each other with a predetermined interval.

According to a sixth aspect of the invention, as set forth in the fifth aspect of the invention, it is preferable that a biasing member that maintains the interval is interposed between the plurality of the fuel cell pairs.

According to a seventh aspect of the invention, as set forth in the fourth aspect of the invention, it is preferable that a high thermal conductive layer is formed on an inner surface of the heat insulating vessel.

According to an eighth aspect of the invention, as set forth in the fourth aspect of the invention, it is preferable that a second fuel cell pair comprising the first solid oxide fuel cell, the second solid oxide fuel cell is arranged above the first fuel cell pair.

According to a ninth aspect of the invention, as set forth in the first aspect of the invention, it is preferable that the heat supplying device supplies flame heat into the fuel cell.

According to a tenth aspect of the invention, as set forth in the ninth aspect of the invention, it is preferable that at least one of the solid oxide fuel cell is exposed directly to the flame.

According to an eleventh aspect of the invention, it is preferable that the solid oxide fuel cell electric power generation apparatus as set forth in the first aspect of the invention, further comprises: a guide rail that supports the solid oxide fuel cells vertically.

According to a twelfth aspect of the invention, it is preferable that the solid oxide fuel cell electric power generation apparatus as set forth in the first aspect of the invention, further comprises: a guide rail that supports the solid fuel vertically.

According to a thirteenth aspect of the invention, as set forth in the eleventh aspect of the invention, it is preferable that

at least two or more guide holes are provided on the solid oxide fuel cell, and

the guide rail is inserted into the guide holes to support the solid oxide fuel cell.

According to a fourteenth aspect of the invention, as set forth in the eleventh aspect of the invention, it is preferable that

the solid oxide fuel cells are arranged to be movable in a horizontal direction, and

the guide rail comprises a spring member that biases the solid oxide fuel.

According to a fifteenth aspect of the invention, as set forth in the eleventh aspect of the invention, it is preferable that a metallic mesh supports the solid oxide fuel cell, and

the solid fuel comprises a retaining member by which the solid fuel is retained to the guide rail.

As mentioned above, the solid oxide fuel cell electric power generation apparatus of the invention comprises a solid fuel provided interposed between two sheets of solid oxide fuel cell each having a cathode electrode layer and an anode electrode layer so that the fuel cell pair can be heated. Thus, by the structure can be simplified so that no sealing is required, the solid fuel can be put directly in gas phase and the apparatus can generate power using this gas phase fuel.

In the solid oxide fuel cell electric power generation apparatus of the invention, a heat-conductive plate is provided on the inner surface of the heat insulating vessel in which a plurality of fuel cell pairs having two sheets of solid oxide fuel cell provided with a solid fuel provided therebetween. In this arrangement, the heat which has been supplied into the lower part of the fuel cell pairs can be rapidly conducted upward, causing the fuel cell pairs to be heated not only at the lower part thereof but also at the side of the upper part thereof. Thus, the occurrence of thermal shock during heating can be relaxed. Further, the driving of electricity generation can be quickly started.

Further, two sheets of solid oxide fuel cell having no solid fuel provided therebetween are vertically disposed above the plural fuel cell pairs in such an arrangement that the anode electrode layer of the two sheets of solid oxide fuel cell are opposed to each other while the cathode electrode layer of the two sheets of solid oxide fuel cell are disposed outside. In this arrangement, the anode electrode layers are supplied with unused fuel seeds produced from the solid fuel in the corresponding fuel cell pair disposed thereunder and thus can be kept fuel-rich so that the fuel seeds which have not been completely used can be effectively used to enhance the utilization efficiency of solid fuel.

Moreover, in the solid oxide fuel cell electric power generation apparatus of the invention, as a heat supplying device for heating the fuel cell pair having two sheets of solid oxide fuel cell provided with a solid fuel interposed therebetween, there can be used flame generated in a burner that can be easily handled. Further, the characteristics that the solid oxide fuel cell can generate power by being exposed directly to flame can be utilized. Thus, by disposing the solid oxide fuel cell between flame and the fuel cell pair, the solid oxide fuel cell is heated by flame. The fuel seeds contained in the flame is used to generate electricity. At the same time, flame is used as a heat source for the fuel cell pair. Accordingly, a simple heat supplying device can be formed.

### BRIEF DESCRIPTION OF THE DRAWINGS

FIG. 1 is a view showing a basic configuration of a solid oxide fuel cell electric power generation apparatus according to the invention;

FIG. 2 is a view showing a first embodiment of the solid oxide fuel cell electric power generation apparatus according to the invention;

FIG. 3 is a view showing a specific example of the solid oxide fuel cell electric power generation apparatus according to the first embodiment;

FIG. 4 is a view showing a second embodiment of the solid oxide fuel cell electric power generation apparatus according to the invention;

FIG. 5 is a view showing a third embodiment of the solid oxide fuel cell electric power generation apparatus of the invention;

FIG. 6 is a view showing a fourth embodiment of the solid oxide fuel cell electric power generation apparatus according to the invention;

FIG. 7 is a view showing a fifth embodiment of the solid oxide fuel cell electric power generation apparatus according to the invention;

FIG. 8 is a view showing a sixth embodiment of the solid oxide fuel cell electric power generation apparatus according to the invention;

FIG. 9 is a view showing the sixth embodiment of the solid oxide fuel cell electric power generation apparatus according to the invention viewed from a longitudinal direction of a guide rail;

FIG. 10 is a view showing a producing method of the solid fuel according to the invention;

FIG. 11 is a view showing a solid oxide fuel cell electric power generation apparatus which directly utilizes flame to generate electricity; and

FIG. 12 is a view showing a solid oxide fuel cell electric power generation apparatus which directly utilizes flame generated by the combustion of a solid fuel.

### DETAILED DESCRIPTION OF EXEMPLARY EMBODIMENTS OF THE INVENTION

### Embodiments

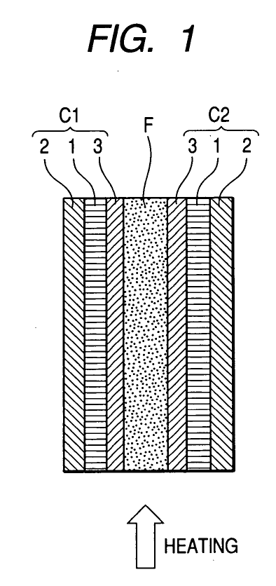

An embodiment of an electric power generation apparatus utilizing the solid oxide fuel cell according to the invention will be described hereinafter in connection with the attached drawings. FIG. 1 depicts the basic configuration of the solid oxide fuel cell electric power generation apparatus according to the present embodiment.

In the electric power generation apparatus utilizing a solid oxide fuel cell shown in FIG. 12, a solid fuel is combusted in a combustion device to generate flame. The generated flame supplies fuel seeds into the anode electrode layer and heats the solid oxide fuel cell. However, in the present embodiment, the solid fuel is not combusted to generate flame, instead, the solid fuel is heated so as to be flamelessly combusted. The fuel seeds generated by the flameless combustion are then directly supplied into the anode electrode layer of the solid oxide fuel cell.

As shown in FIG. 1, two sheets of flat solid oxide fuel cell C1, C2 each having a solid electrolyte substrate 1 having a cathode electrode layer 2 and an anode electrode layer 3 formed thereon are disposed so that its anode electrode layer 3 is provided its inside. A flat solid fuel F is disposed between the anode electrode layers 3. Thus, a fuel cell pair having the solid fuel F disposed between the solid oxide fuel cells C1 and C2 and in contact with the each electrodes is formed.

In the basic configuration shown in FIG. 1, the fuel cell pair disposed in the atmosphere is heated by a heat supplying device (not shown) at the lower part thereof. As the heat supplying device there may be used an electric oven which is supplied with air. In this case, the fuel cell pair is accommodated in the electric oven. Alternatively, the heat supplying device may be merely a gas burner capable of generating flame or an electric heater.

When the solid fuel F can be shaped such that it can be disposed between the flat solid oxide fuel cells C1 and C2, it is advantageous. Therefore, the solid fuel F is preferably shaped flat. As the solid fuel F there is preferably used an aggregated chip or pellet of wood plate, veneer, paper or wood material, which can be easily available.

While the fuel cell pair is shown disposed vertically in FIG. 1, the fuel cell pair is not necessarily disposed vertically. The fuel cell pair may be disposed in any arrangement, e.g., horizontally so far as the cathode electrode layer 2 can be supplied with air or oxygen-containing gas. The heat supplying device may be of any type capable of keeping the solid oxide fuel cells at the operating temperature required for the solid oxide fuel cells to generate electricity. When it reaches this operating temperature, the aforementioned solid fuel can be flamelessly combusted to generate fuel seeds.

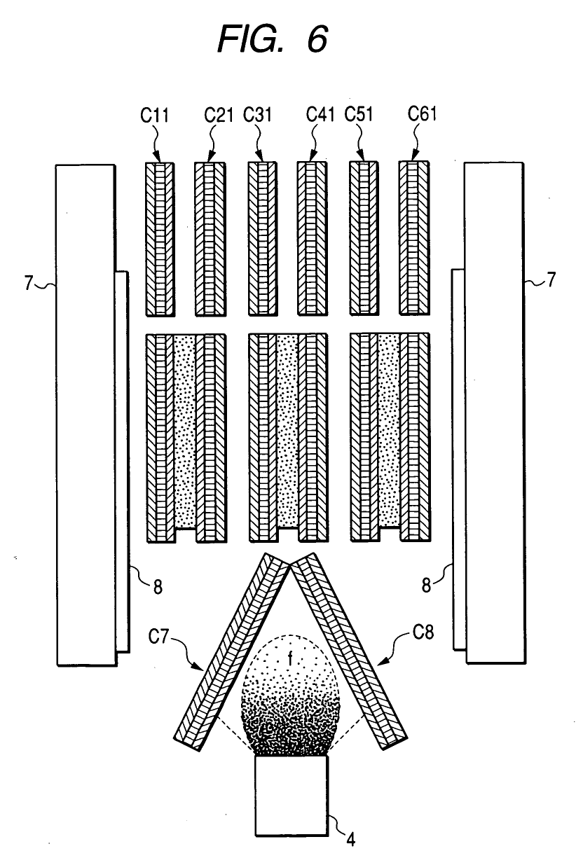

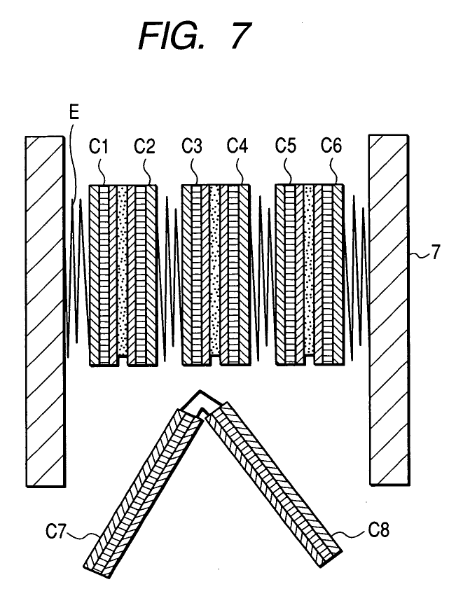

The solid oxide fuel cell to be used in the electric power generation apparatus according to the present embodiment will be described hereinafter. As each of the solid oxide fuel cells C1, C2 to be used herein there may be used one having the same configuration as that of the solid oxide fuel cell C shown in FIGS. 6 and 7.

The solid oxide fuel cells C1, C2 each are formed flat and have a cathode electrode layer 2 disposed on one side of the solid electrolyte substrate 1 and an anode electrode layer 3 disposed on the other side of the solid electrolyte substrate 1. In this arrangement, when the anode electrode layer 3 is disposed opposed to the fuel seed supplying side, the cathode electrode layer 2 is disposed on the side opposite the fuel seed supplying side, making it possible to distinguish between fuel-rich state and oxygen-rich state. Thus, with the solid oxide fuel cells C1, C2 kept open, the cathode electrode layer 2 can easily utilize oxygen in the atmosphere and thus can be kept oxygen-rich.

As a solid electrolyte substrate 1 there may be used, e.g., any known material. Examples of such a material include the following materials.
a) YSZ (yttria-stabilized zirconia), ScSZ (scandia-stabilized zirconia), zirconia-based ceramics obtained by doping these materials with Ce, Al or the like
b) Ceria-based ceramics such as SDC (samaria-doped ceria) and GDC (gadolia-doped ceria)
c) LSGM (lanthanum gallate), bismuth oxide-based ceramics

As an anode electrode layer 3 there may be used, e.g., any known material. Examples of such a material include the following materials.
d) Cermets of nickel with yttria-stabilized zirconia-based, scandia-stabilized-based or ceria-based (e.g., SDC, GDC, YDC) ceramics
e) Sintered material mainly composed of an electrically-conductive oxide (50% to 99% by weight) (As the electrically-conductive oxide there may be used nickel oxide having lithium dissolved in solid state therein or the like)
f) Metal made of platinum element, rhenium or oxide thereof incorporated in the materials d) and e) in an amount of from 1% to 10% by weight
   Particularly Preferred Among these Materials are Materials d) and e).

Due to its excellent oxidation resistance, the sintered material mainly composed of the electrically-conductive oxide e) can prevent phenomena occurring due to the oxidation of the anode layer, e.g., drop of electricity generation efficiency or incapability of electricity generation due to the rise of the electrode resistivity of the anode layer and exfoliation of the anode layer from the solid electrolyte layer. As the electrically-conductive oxide there is preferably used nickel oxide having lithium dissolved in solid state. Further, the incorporation of metal such as platinum group element or rhenium or oxide thereof in the materials d) and e) makes it possible to obtain a high electricity generation capability.

As the cathode electrode layer 2 there may be used any known material. Examples of such a material include manganate (e.g., lanthanum strontium manganite), gallium and cobaltate (e.g., lanthanum strontium cobaltate, samarium strontium cobaltate) of an element belonging to the group III such as lanthanum having strontium (Sr) incorporated therein.

The cathode electrode layer 2 and the anode electrode layer 3 each are formed by a porous material. The solid electrolyte substrate 1 in the solid oxide fuel cell C3 used in the present embodiment, too, can be in the form of porous material. As in the related art, the solid electrolyte substrate 1 in the solid oxide fuel cell used in the present embodiment may be in a dense form. However, a dense solid electrolyte substrate exhibits a low thermal shock resistance and thus can be easily cracked by sudden temperature change. In general, the solid electrolyte substrate is formed thicker than the anode electrode layer and the cathode electrode layer. Accordingly, triggered by the cracking of the solid electrolyte substrate, the related art solid oxide fuel cell is entirely cracked. As a result, the solid oxide fuel cell is completely divided into pieces.

The porous solid electrolyte substrate thus formed cannot be cracked against sudden temperature change caused by heating by the heat supplier, even against heat cycle having a great temperature difference during electricity generation. Thus, it makes possible to enhance the thermal shock resistance of the solid oxide fuel cell. As for the percent porosity of the solid electrolyte substrate, although the solid electrolyte substrate is porous, if the percent porosity falls below 10%, the resulting solid oxide fuel cell is not observed to have remarkable enhancement of thermal shock resistance. When the percent porosity of the solid electrolyte substrate is 10% or more, the resulting solid oxide fuel cell is observed to have a good thermal shock resistance. When the percent porosity of the solid electrolyte substrate is 20% or more, the resulting solid oxide fuel cell is observed to have a better thermal shock resistance. This is presumably because when the solid electrolyte layer is porous, the thermal expansion caused by heating is relaxed by voids.

The solid oxide fuel cells C1, C2 are produced by, e.g., the following method. Firstly, powdered solid electrolyte layer materials are mixed at a predetermined ratio. The mixture is then formed into a flat plate. Thereafter, the flat plate is baked and sintered to prepare a substrate as solid electrolyte layer. During this procedure, the kind and mixing ratio of material powders such as pore-forming material and the sintering conditions such as sintering temperature, sintering time and presintering condition can be properly adjusted to prepare solid electrolyte layers having various percent porosities. A paste constituting the cathode electrode layer is spread over the outer surface of the substrate as solid electrolyte layer thus obtained and a paste constituting the anode electrode layer is spread over the inner surface of the substrate. The substrate thus coated is then sintered to produce a solid oxide fuel cell.

The solid oxide fuel cell can have a higher durability as described below. A method for enhancing the durability of the solid oxide fuel cell has a step of embedding a metallic mesh in the cathode electrode layer 2 and the anode electrode layer 3 of the solid oxide fuel cell C1, C2 or fixing the metallic mesh to these electrode layers. The embedding of the metallic mesh in these electrode layers is accomplished by, spreading various materials (pastes) over the solid electrolyte layer, embedding a metallic mesh in the materials thus spread, and then sintering the coated solid electrolyte layer. The fixing of the metallic mesh to these electrode layers may be accomplished by sintering the coated solid electrolyte layer with the metallic mesh bonded thereto without fully embedding the metallic mesh in the various layer materials.

As the metallic mesh there is preferably used one excellent in matching with the cathode electrode layer and anode electrode layer in which it is embedded or to which it is fixed and heat resistance. In some detail, a platinum metal or a metal made of platinum alloy in a mesh form may be used. SUS300 (in JIS: Japanese industrial standard) series stainless steels (#304, #316) or SUS400 series stainless steels (#430) may be used to advantage from the standpoint of cost.

Instead of metallic mesh, a wire metal may be embedded in or fixed to the anode electrode layer and the cathode electrode layer. The wire metal is made of the same metal as the metallic mesh. The number of the wire metals and the configuration of provision of the wire metals are not limited.

When a metallic mesh or wire metal is embedded in or fixed to the anode electrode layer or the cathode electrode layer, the solid electrolyte substrate which has been cracked by thermal history or the like can be reinforced against falling to pieces. Further, the metallic mesh or wire metal can electrically connect these pieces.

While the foregoing description has been made with reference to the case where the solid electrolyte substrate is porous, the solid electrolyte substrate of the solid oxide fuel cell according to the present embodiment may has a dense structure. In this case, the embedding of the metallic mesh or wire metal in the cathode electrode layer and the anode electrode layer is an effective method for coping with cracking due to thermal history in particular.

The metallic mesh or wire metal may be provided in both or either one of the anode electrode layer and the cathode electrode layer. Alternatively, the metallic mesh and the wire metal may be provided in combination. When the metallic mesh or wire metal is embedded in at least the anode electrode layer, the solid oxide fuel cell can continue to generate electricity without deteriorating its electricity generating capacity even if the solid electrolyte substrate is cracked by thermal history. Since the electricity generating capacity of a solid oxide fuel cell depends greatly on the effective area of the anode electrode layer as a fuel electrode, it is preferred that the metallic mesh or wire metal be provided in at least the anode electrode layer.

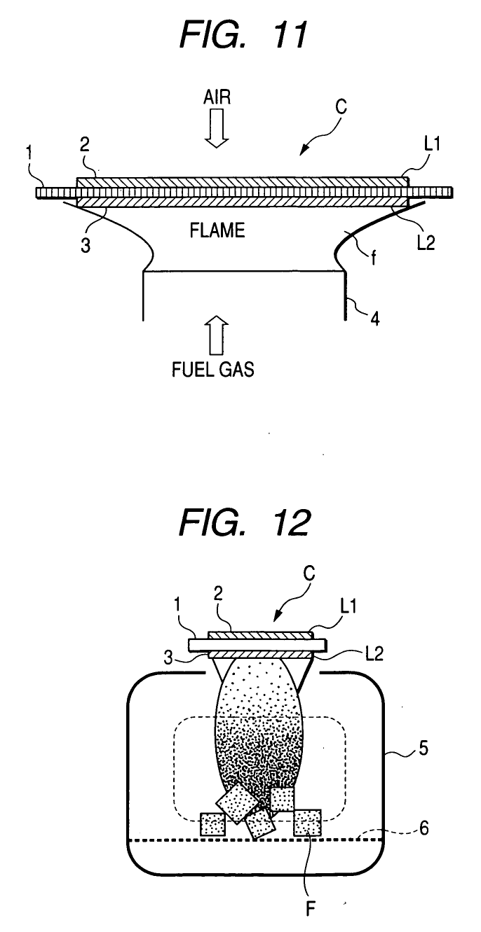

Although not shown in FIG. 1, the solid oxide fuel cells C1, C2 to be used in the electric power generation apparatus according to the present embodiment each have lead wires L1, L2 for drawing electromotive force attached thereto at the cathode electrode layer 2 and the anode electrode layer 3, respectively, as shown in FIGS. 11 and 12. The solid oxide fuel cells C1 and C2 are electrically connected parallel to or in series with each other depending on the manner in which these lead wires L1 and L2 are connected.

### First Embodiment

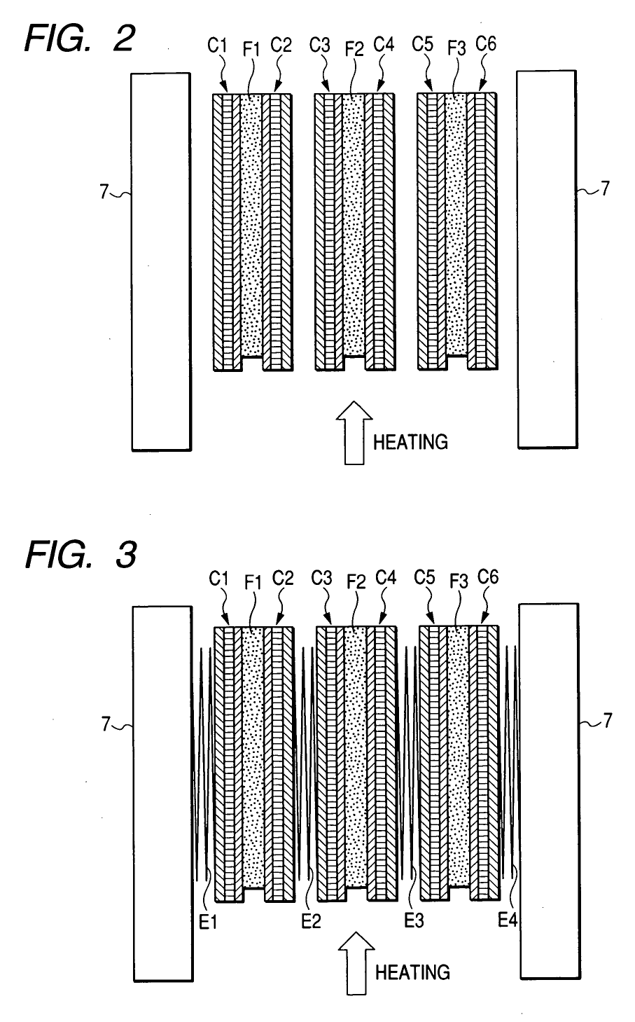

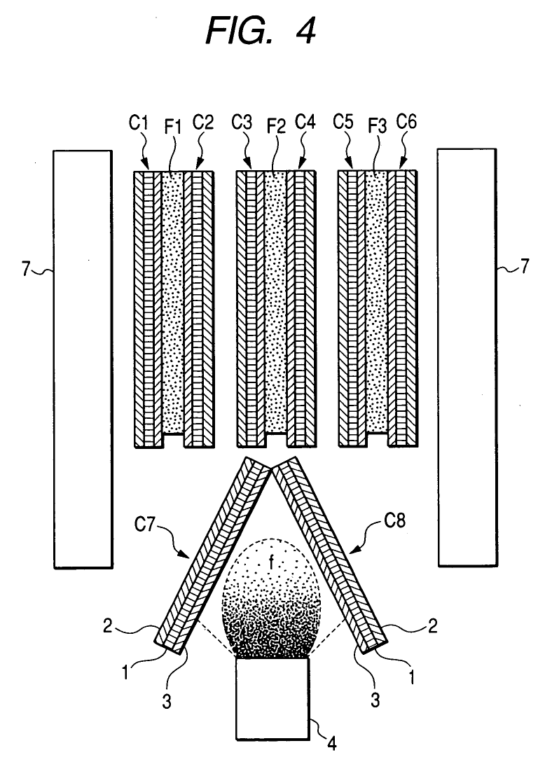

A first embodiment of the solid oxide fuel cell electric power generation apparatus having the basic configuration according to the invention shown in FIG. 1 is shown in FIG. 2. In the first embodiment, a heat insulating vessel 7 surrounds at least a part of a side portion of a plurality of fuel cell pairs each having a solid fuel provided between two sheets of solid oxide fuel cell are disposed vertically apart from each other at a predetermined interval so as to accommodate the fuel cell pairs therein. In the example shown in FIG. 2, three sets of fuel cell pair are disposed in the heat insulating vessel 7.

The first fuel cell pair has a solid fuel F1 and solid oxide fuel cells C1 and C2. The second fuel cell pair has a solid fuel F2 and solid oxide fuel cells C3 and C4. The third fuel cell pair has a solid fuel F3 and solid oxide fuel cells C5 and C6. The heat insulating vessel 7 is supplied with heat at the lower part thereof for heating the plural fuel cell pairs by a heat supplying device (not shown).

Since the heat insulating vessel 7 is open to the atmosphere at the lower part thereof, air which has been heated by the heat supplying device flows naturally upward through the gap between the plural fuel cell pairs so that the cathode electrode layer of the solid oxide fuel cells constituting the plural fuel cell pairs are supplied with air and rendered oxygen-rich. To this end, the plural fuel cell pairs need to be disposed apart from each other at a predetermined interval to assure air channel. While the heat insulating vessel 7 is shown open at the upper part thereof in FIG. 2, the heat insulating vessel 7 may be closed at the upper part thereof and provided with an opening for allowing the passage of discharge gas and ascending air flow.

On the other hand, when heated at the lower part thereof, the solid fuels F1 to F3 each are flamelessly combusted to generate fuel seeds such as hydrocarbon, hydrogen and radical (OH, CH, C₂, O₂H, CH₃). Since the solid fuels F1 to F3 each are disposed in contact with the anode electrode layer of the solid oxide fuel cells, the fuel seeds generated from the solid fuels F1 to F3 are supplied directly into the anode electrode layer of the solid oxide fuel cells in the plural fuel cell pairs to keep the anode electrodes layer fuel-rich.

A specific example of the solid oxide fuel cell electric power generation apparatus according to the first embodiment shown in FIG. 2 is shown in FIG. 3. In the case of FIG. 2, in order to keep the cathode electrode layer of the solid oxide fuel cells constituting the plural fuel cell pairs oxygen-rich, the plural fuel cell pairs need to be disposed apart from each other at a predetermined interval to assure air channel. To this end, the specific example shown in FIG. 3 is provided with a specific means for keeping the plural fuel cell pairs apart from each other at a predetermined interval.

The solid oxide fuel cell electric power generation apparatus shown in FIG. 3 is an example having the same configuration as that of the electric power generation apparatus shown in FIG. 2. As a specific means for keeping the fuel cell pairs apart from each other at a predetermined interval, elastic members (biasing member) E1 to E4 are disposed between the plural fuel cell pairs and between each of the fuel cell pairs and the inner surface of the heat insulating vessel 7. The elastic members E1 to E4 each act to retain the plural fuel cell pairs by pressing against the fuel cell pairs like a spring, for example. The provision of the elastic members E1 to E4 facilitates the detachment of the fuel cell pairs from the heat insulating vessel easily when the combusted solid fuel disposed between the fuel cell pairs is replaced by a fresh solid fuel.

### Second Embodiment

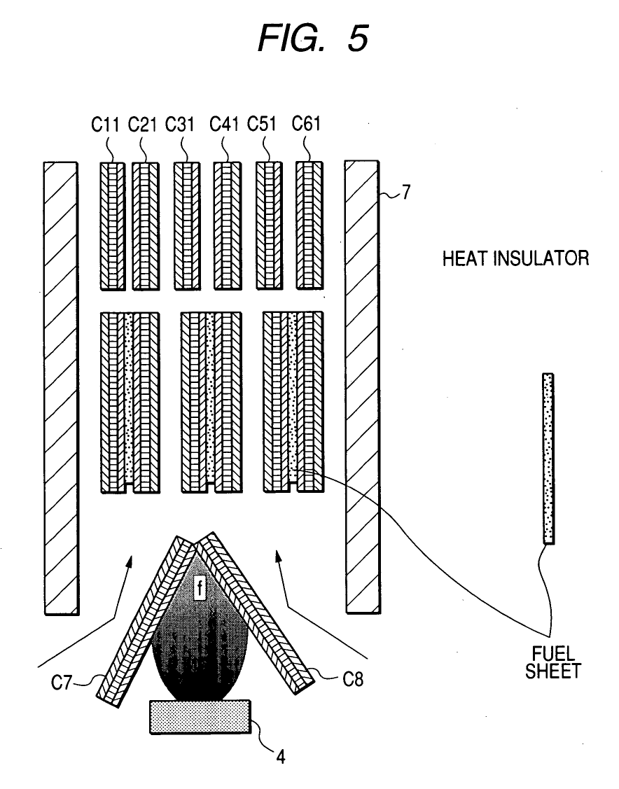

A second embodiment of the solid oxide fuel cell electric power generation apparatus according to the invention is shown in FIG. 4. The solid oxide fuel cell electric power generation apparatus according to the second embodiment is based on the same configuration as that of the electric power generation apparatus according to the first embodiment shown in FIG. 2 Different from the first embodiment is in that a burner which generates flame is used as the heat supplying device to be provided under the heat insulating vessel 7.

The solid oxide fuel cell electric power generation apparatus shown in FIG. 2 also can use as a heat supplying device a burner which generates flame. Due to this flame, the plural fuel cell pairs can be heated to the operating temperature and the solid fuel can be flamelessly combusted to generate electricity. However, at the part of the fuel cell pairs where the solid fuel is directly exposed to flame, i.e., lower part of the solid fuel, the combustion of the solid fuel cannot be avoided.

Focusing on the fact that the plural fuel cell pairs are sufficient if they is heated to keep the desired operating temperature can be kept, in the electric power generation apparatus according to the second embodiment, the solid oxide fuel cell itself is capable of directly utilizing flame to generate electricity. In this case, the solid oxide fuel cell itself acts as a heating element.

The electric power generation apparatus according to the second embodiment shown in FIG. 4 is based on the same configuration as that of the first embodiment shown in FIGS. 2 and 3 and is provided at the lower part of the heat insulating vessel 7 with the solid oxide fuel cells C7, C8 and a burner 4 for supplying flame f to the fuel cells. The burner 4 is supplied with a premixed gas which is then combusted to generate flame f.

The solid oxide fuel cells C7 and C8 each are disposed in such an arrangement that the anode electrode layer 3 formed thereon is exposed to flame f generated by the burner 4. While two sheets of solid oxide fuel cell are shown disposed in FIG. 4, a sheet of solid oxide fuel cell maybe disposed horizontally. Further, it may be arranged such that the flame f is surrounded by a plurality of sheets of solid oxide fuel cell so far as the flame f merely acts as a heat source but does not apply directly to the fuel cell pairs.

In the electric power generation apparatus according to the second embodiment shown in FIG. 4, two sheets of solid oxide fuel cell C7 and C8 are disposed so that its anode electrode layer 3 is provided inside and closed at the upper end thereof to form a space thereinside. The space thus formed is supplied with flame f generated by the burner 4 by which the two sheets of solid oxide fuel cell C7 and C8 are heated to act as a heat source for heating the plural fuel cell pairs. The flame f is applied directly to the anode electrode layer 3 of the solid oxide fuel cells C7 and C8 so that fuel seeds are supplied thereinto to contribute to the generation of electricity by the solid oxide fuel cells C7 and C8. In this arrangement of heat supplying device, the flame f thus generated can be effectively utilized.

### Third Embodiment

FIG. 5 depicts a third embodiment of the solid oxide fuel cell electric power generation apparatus according to the invention. The electric power generation apparatus according to the third embodiment is based on the same configuration as that of the solid oxide fuel cell electric power generation apparatus according to the second embodiment shown in FIG. 4. Different from the second embodiment is in that a plurality of sheets of solid oxide fuel cell are disposed on the top of the plural fuel cell pairs.

Further, as shown in FIG. 5, at the top of the plural fuel cell pairs in the electric power generation apparatus according to the third embodiment, two sheets of solid oxide fuel cell having no solid fuel interposed therebetween are disposed vertically in correspondence to each of the first fuel cell pairs. In some detail, solid oxide fuel cells C11, c21 are disposed in correspondence to the first fuel cell pair composed of solid fuel F1 and solid oxide fuel cells C1 and c2. Solid oxide fuel cells C31, c41 are disposed in correspondence to the second fuel cell pair composed of solid fuel F2 and solid oxide fuel cells C3 and c4. Solid oxide fuel cells C51, C61 are disposed in correspondence to the third fuel cell pair composed of solid fuel F3 and solid oxide fuel cells C5 and c6.

Sets of two sheets of solid oxide fuel cell disposed at the upper part of the heat insulating vessel 7 each are disposed with the anode electrode layer of the two sheets of solid oxide fuel cell opposed to each other and the cathode electrode layer of the two sheets of solid oxide fuel cell outside. In this arrangement of the solid oxide fuel cells C11 to C61, the anode electrode layer of the solid oxide fuel cells C11 and C21, for example, are supplied with unused fuel seeds produced from the solid fuel in the underlying corresponding fuel cell pair and thus can be kept fuel-rich. The cathode electrode layer of the solid oxide fuel cells C11 and C21 each are supplied at the lower part thereof with heated air and thus can be kept oxygen-rich. This applies also to the other solid oxide fuel cells C31 to C61.

In the case of the first embodiment of FIGS. 2 and 3 and the second embodiment of FIG. 4, the fuel seeds generated from the solid fuel provided interposed between the pair of fuel cells are scattered upward and lost if they cannot be completely used in the solid oxide fuel cells. In the electric power generation apparatus according to the third embodiment shown in FIG. 5, a plurality of sheets of solid oxide fuel cell are disposed in correspondence to the respective fuel cell pair. In this arrangement, fuel seeds which have been generated in the plural fuel cell pairs but not completely used can be effectively used, making it possible to enhance the utilization efficiency of fuel. Fuel cell pairs having no solid fuel interposed therebetween can be disposed in the electric power generation apparatus according to the first embodiment of FIGS. 2 and 3 to enhance the utilization efficiency of fuel similarly to the case of the third embodiment.

### Fourth Embodiment

Furthermore, FIG. 6 shows a fourth embodiment of the invention. The electric power generation apparatus according to the fourth embodiment is based on the same configuration as that of third embodiment of the solid oxide fuel cell electric power generation apparatus as shown in FIG. 4. Different from the third embodiment is in that a heat-conductive plate 8 is provided on an inner surface of the heat insulating vessel 7.

As shown in FIG. 6, the heat-conductive plate 8 is provided on the inner surface of the heat insulating vessel 7. According to this arrangement, in addition to the advantageous of the third embodiment of the invention, following advantageous is achieved. Since the heat which has been supplied into the lower part of the plural fuel cell pairs can be rapidly conducted upward, the plural fuel cell pairs to be heated not only at the lower part thereof but also at the side of the upper part thereof. Thus, the occurrence of thermal shock during heating can be relaxed. Further, the driving of electricity generation can be quickly started. The heat-conductive plate can be applied also to the electric power generation apparatus according to the first embodiment shown in FIGS. 2 and 3, even to the electric power generation apparatus according to the second embodiment shown in FIG. 4.

### Fifth Embodiment

FIG. 7 shows a fifth embodiment of the invention. In the fifth embodiment, the first embodiment shown in FIG. 3 is combined with the second embodiment shown in FIG. 4. That is, in the fifth embodiment, an upper structure of FIG. 3 and a lower structure of FIG. 4 are combined together to make the fifth embodiment.

In some detail, in the upper structure, the elastic member E is provided between the each fuel cell pairs and between the insulating vessel and the fuel cell pair. Further, in the lower structure, the solid oxide fuel cells C7 and C8 surrounds the burner 4.

According to this structure, fuel seeds contained in the flame f contributes the fuel cell pairs in the lower structure, and the fuel cell pairs in the upper structure is heated by the flame so as to generate electric power. In addition, since the each fuel cell pairs are supported by the elastic members E, exchange of completely-combusted solid fuel can be easily.

### Sixth Embodiment

In the above-described first to fifth embodiments, the each fuel cells are, for an example, hanged by the lead wire, or supported by a support member.

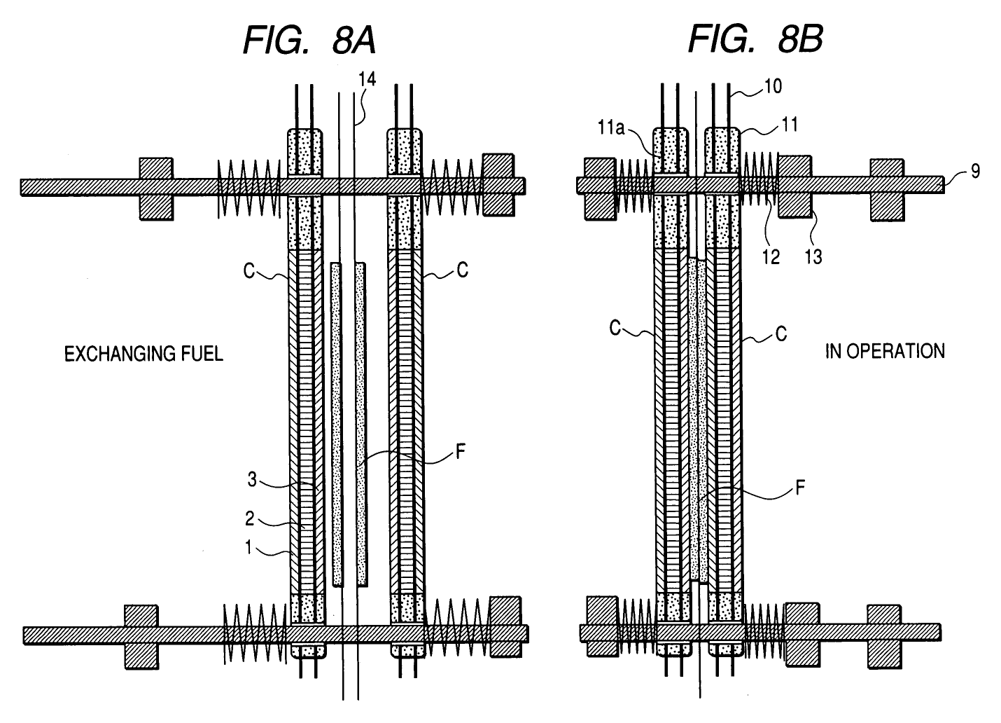

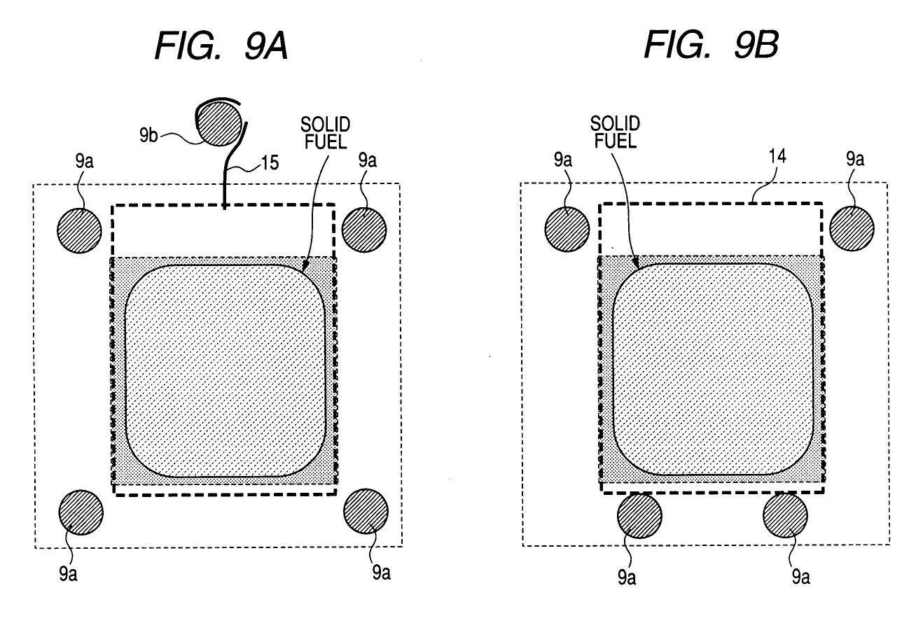

As a sixth embodiment, there is provided a solid fuel cell electric power generation apparatus provided with a guide rail as the support member. FIG. 8A shows the sixth embodiment when exchanging the solid fuel, FIG. 8B shows the sixth embodiment when the fuel cell is in operation. FIGS. 9A and 9B are views of the solid fuel cell electric power generation apparatus provided with a guide rail as the support member of the sixth embodiment viewed from a longitudinal direction of the guide rail 9.

A guide rail 9 shown in FIGS. 8A and 8B is arranged within the insulating vessel 7 in a horizontal direction. As for the guide rail 9, heat resistive alloy is preferably employed. The guide rail 9 is formed in a rod shape. Further, on an outer circumferential surface of the guide rail 9, screw cutting may be performed.

The fuel cell pairs employ a metallic mesh 10 embedded in the respective electrode substrates as a electric correcting member. A coating portion 11 made of thermal insulating material covers outer peripheral portions of the metallic mesh. For this thermal insulating material, oxide solidified in low temperature, for an example, commercially available ceramic adhesive agent is preferably used. To this coating portion 11, guide holes 11a are formed at two through four portions so as to penetrate the metallic mesh 10. In this structure, the guide holes 11a are coated with an electric insulating material having high thermal resistivity. To the guide holes 11a, the guide rail 9 is inserted in such a manner that the same kind of electrode opposes each other. The guide rail 9 supports the solid oxide fuel cell or solid fuel vertically.

After disposing the solid fuel between the fuel cells, moving the fuel cells having the solid fuel in the horizontal direction. By using a spring member 12, the fuel cells are pushed in the horizontal direction so that the solid fuel contact with the anode electrode surely, and then fix them by a fixing member 13. In some detail, the spring member may be made of thermal resistance alloy, and the fixing member may be a nut made of thermal resistance alloy. The guide rail 9 is inserted into the spring member 12 and the fixing member 13 is fixed to the screwed guide rail 9.

When exchanging the solid fuel, at first, moving away the fixing member 13 from the fuel cell, taking out the used solid fuel, inserting a new solid fuel and again fixing the fuel cell by the fixing member 13.

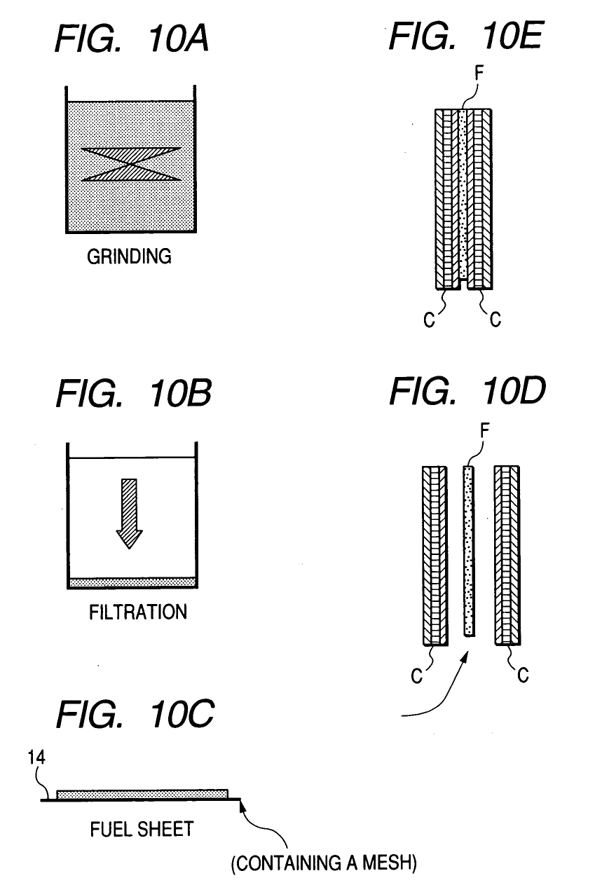

Note that as for the solid fuel, various materials can be employed. Raw garbage having much water, organic solid body dispersed in water can be utilized as the solid fuel. FIGS. 10A through 10E show producing method of the solid fuel. For these organic solid material, preferably, by grinding (FIG. 10A) and filtrating if necessary and depositing them on a mesh 14 with a substantially even thickness (FIG. 10B), they can be utilize as the solid fuel (FIG. 10C). In this solid fuel, the mesh 14 is positioned on one side of the solid fuel. Thus obtained solid fuel on the mesh may be sandwiched between a pair of the fuel cell (FIG. 10D) and make them to the fuel cell pair used in the first embodiment (FIG. 10E). Further, the meshes in the used solid fuel can be recycled for the next filtration. Also, ash which is remained in the used solid fuel can be use as fertilizer.

Thus obtained solid fuels are employed in the above-described sixth embodiment so that two solid fuels make a pair and the paired solid fuels is combined so that the meshes of the solid fuels face to each other. Thus combined solid fuels are disposed between the anode electrodes.

As shown in FIG. 9B, the guide rail 9 may be located on a bottom portion of the solid fuel so as to support the solid fuel. In stead, as shown in FIG. 9A, a hook 15 may be provided on the mesh 14 in the solid fuel and the hook 15 may be hung on the guide rail 9. In this structure, there can be provided a guide rail 9a for supporting the fuel cells and a guide rail 9b for supporting the solid fuel on which the hook 15 is hanged, separately.

Embodiments of the solid oxide fuel cell electric power generation apparatus which operates by heating a fuel cell pair having a solid fuel interposed between two sheets of solid oxide fuel cell to cause the solid fuel to generate fuel seeds that are then used to generate electricity have been described above. An example of the solid oxide fuel cell electric power generation apparatus according to the invention will be described hereinafter.

### EXAMPLES

A mixture of a Samarium-Doped Ceria (Ce_{0.8}Sm_{0.2}O_{1.9}, SDC) powder, a polyvinyl butyral and dibutyl phthalate was slurried by a ball mill method. A green sheet having a thickness of about 0.2 mm was then prepared from the thus obtained slurry. A disc plate was then stamped out from the green sheet. Thereafter, the plate was sintered at 1,300° C. in the atmosphere to obtain a solid electrolyte substrate having a diameter of about 15 mm.

A paste of a 50 wt % mixture of Samarium Strontium Cobaltite (SSC) and SDC was printed on one side of the solid electrolyte substrate while a paste of a 15:45:40 mixture (by weight) of NiO, CoO and SDC was printed on the other side of the solid electrolyte substrate. A platinum mesh (#80) having a platinum wire welded to each other was then embedded in the pastes. The coated solid electrolyte substrate was then sintered at 1,200° C. in the atmosphere.

A pair of the solid oxide fuel cells thus prepared were then accommodated in a ceramic tube with its anode electrode layers opposed to each other and a wood piece having a weight of about 0.5 g provided interposed therebetween in such a manner that the solid oxide fuel cells can be biased from the both cathode electrode layer sides thereof. This tube was inserted in an electric oven where it was then evaluated for electricity generating capacity. As a result, the short circuit current was 44 mA at maximum at 690° C. The electric current could be drawn for about 20 minutes.

A test specimen was prepared in the same manner as above except that eight sheets of paper having a thickness of 0.3 mm (about 0.4 g) were provided interposed between the pair of solid oxide fuel cells. The test specimen was then evaluated for electricity generating capacity. As a result, the short circuit current was 86 mA at maximum at 620° C. The electric current could be drawn for about 15 minutes.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A solid oxide fuel cell electric power generation apparatus comprising:
first and second solid oxide fuel cells each comprising a flat solid electrolyte substrate having a cathode electrode layer and an anode electrode layer; and
a heat supplying device that heats the first and second solid oxide fuel cells,
wherein a solid fuel is provided between the anode electrode layer of the first solid oxide fuel cell and the anode electrode layer of the second solid oxide fuel cell.

2. The solid oxide fuel cell electric power generation apparatus according to claim 1, wherein a metallic mesh is provided on the anode electrode layers.

3. The solid oxide fuel cell electric power generation apparatus according to claim 1,
wherein a heat insulating vessel surrounds at least a part of a side portion of a first fuel cell pair comprising the first solid oxide fuel cell, the second solid oxide fuel cell and the solid fuel provided therebetween and
the heat supplying device is disposed at a lower part of the heat insulating vessel and air is supplied into the heat insulating vessel from the lower part thereof.

4. The solid oxide fuel cell electric power generation apparatus according to claim 3,
wherein the first fuel cell pair is disposed vertically and
the heat supplying device is disposed under the first fuel cell pair.

5. The solid oxide fuel cell electric power generation apparatus according to claim 4, wherein a plurality of the fuel cell pairs comprising the first solid oxide fuel cell, the second solid oxide fuel cell and the solid fuel provided therebetween, are accommodated in the heat insulating vessel so as to be apart from each other with a predetermined interval.

6. The solid oxide fuel cell electric power generation apparatus according to claim 5, wherein a biasing member that maintains the interval is interposed between the plurality of the fuel cell pairs.

7. The solid oxide fuel cell electric power generation apparatus according to claim 4, wherein a high thermal conductive layer is formed on an inner surface of the heat insulating vessel.

8. The solid oxide fuel cell electric power generation apparatus according to claim 4,
wherein a second fuel cell pair comprising the first solid oxide fuel cell, the second solid oxide fuel cell is arranged above the first fuel cell pair.

9. The solid oxide fuel cell electric power generation apparatus according to claim 1, wherein the heat supplying device supplies flame heat into the fuel cell.

10. The solid oxide fuel cell electric power generation apparatus according to claim 9, wherein at least one of the solid oxide fuel cell is exposed directly to the flame.

11. The solid oxide fuel cell electric power generation apparatus according to claim 1, further comprising:
a guide rail that supports the solid oxide fuel cells vertically.

12. The solid oxide fuel cell electric power generation apparatus according to claim 1, further comprising a guide rail that supports the solid fuel vertically.

13. The solid oxide fuel cell electric power generation apparatus according to claim 11, wherein
at least two or more guide holes are provided on the solid oxide fuel cell, and
the guide rail is inserted into the guide holes to support the solid oxide fuel cell.

14. The solid oxide fuel cell electric power generation apparatus according to claim 11, wherein
the solid oxide fuel cells are arranged to be movable in a horizontal direction, and
the guide rail comprises a spring member that biases the solid oxide fuel.

15. The solid oxide fuel cell electric power generation apparatus according to claim 11, wherein
a metallic mesh supports the solid oxide fuel cell, and
the solid fuel comprises a retaining member by which the solid fuel is retained to the guide rail.
